(19) United States
(12) Patent Application Publication
(10) Pub. No.: US 2004/0267606 A1
(43) Pub. Date: Dec. 30, 2004

(54) Method, system, and storage medium for supplemental workforce procurement and management

(75) Inventors: Heidi L. Brishke, Clermont, FL (US); Kathryn A. Browning, Hillsborough, NC (US); Pamela K. Howard, Cicero, IN (US); Gautam Majumdar, Danbury, CT (US); Allison M. McCormack, Hopewell Junction, NY (US); Russell E. Parks, Marlboro, NY (US)

Correspondence Address: Philmore H. Colburn II, CANTOR COLBURN LLP, 55 Griffin Road South, Bloomfield, CT, 06002, US

(73) Assignee: International Business Machines Corporation, Armonk, NY

(21) Appl. No.: 10/610,946

(22) Filed: Jun. 30, 2003

(51) Int. Cl. G06F 17/60

(52) U.S. Cl. 705/11; 705/1; 705/10

(57) ABSTRACT

An exemplary embodiment of the invention relates to a method, system, and storage medium for supplemental workforce procurement and management. The method comprises: receiving a request form from a hiring entity for a supplemental worker that includes a work location, at least one skill type, a skill level associated with the at least one skill type, and a quantity of supplemental workers required for performing the job; generating a list of at least one supplier candidate that satisfies the criteria provided in the request form by accessing a data repository; and providing the list of at least one supplier candidate to the hiring entity. The data repository stores predefined skill types, predefined skill levels, supplier locations, and pre-negotiated pay rates. The method also comprises automatically transmitting the request form to a requisitioning tool for generating a requisition and automatically transmitting the requisition to a procurement engine for generating a purchase order. Other embodiments include a system and a storage medium

### BACKGROUND OF THE INVENTION

This invention relates generally to contract employment practices, and more particularly, this invention relates to a method, system, and storage medium for supplemental workforce procurement and management over an electronic network.

The costs normally associated with human resources is known to be one of the largest capital expenses for any business enterprise. Typical challenges faced by businesses today include employee attrition due to deficient recruiting practices, inadequate training, and poor retention plans. Further, shortages in certain fields or skills caused by economic factors can create significant delays for the business in reaching its objectives. Fluctuations in market demand can result in unexpected surges in production that can temporarily leave a business critically shorthanded.

In order to stay competitive, businesses are continually looking for new and improved methods and models for managing human capital in order to deliver the desired services to their customers. A recent technique employed for conserving human resources is business process re-engineering. Business roles and hierarchical organizational structures are broken down and revamped, resulting in a merger of some job positions, or the elimination or re-definition of job roles. Employing an optimum number and type of employees that is proportionate to the nature and extent of work presented is not an easy task for the human resources department. Because the nature and quantity of work fluctuates according to changing market demands, development of new business plans, as well as by unforeseen circumstances, the ideal number and skill level of employees can change sporadically.

One solution to this fluctuation in human resource needs is to engage in contract hiring whereby human resource agencies contract out individuals on a temporary basis for a fee. While this solution has its advantages, it can be cumbersome and inefficient for larger organizations which employ large numbers of contractors over a significant geographical area. Projects of the hiring organization may require a wide variety of specialized skills to be performed at any number of locations for varying periods of time. The frequency of such hiring needs also plays a factor in the manageability of contract hiring. Thus, a large national or global business which frequently utilizes contract employees will likely find it difficult using existing staffing techniques.

It is therefore desirable to provide a method and system for supplemental workforce procurement and management.

### SUMMARY OF THE INVENTION

An exemplary embodiment of the invention relates to a method, system, and storage medium for supplemental workforce procurement and management. The method comprises: receiving a request form from a hiring entity for a supplemental worker that includes a work location, at least one skill type, a skill level associated with the at least one skill type, and a quantity of supplemental workers required for performing the job; generating a list of at least one supplier candidate that satisfies the criteria provided in the request form by accessing a data repository; and providing the list of at least one supplier candidate to the hiring entity. The data repository stores predefined skill types, predefined skill levels, supplier locations, and pre-negotiated pay rates. The method also comprises automatically transmitting the request form to a requisitioning tool for generating a requisition and automatically transmitting the requisition to a procurement engine for generating a purchase order.

### BRIEF DESCRIPTION OF THE DRAWINGS

Referring now to the drawings wherein like elements are numbered alike in the several FIGURES:

FIG. 1 is a block diagram of a portion of the system that includes a plurality of workstations and a server on which the supplemental workforce system is implemented in an exemplary embodiment;

FIG. 2 is a flowchart describing the requisition request process implemented via the supplemental workforce system in an exemplary embodiment; and

FIG. 3 illustrates an exemplary request form accessible via the supplemental workforce application in an exemplary embodiment.

### DETAILED DESCRIPTION OF THE PREFERRED EMBODIMENT

The supplemental workforce system is used to facilitate the hiring of contract personnel for a variety of employment opportunities. It provides a centralized storage system in which workforce requisition documents can be created, edited, viewed, tracked and closed by a variety of users of an organization on a tiered access basis. The supplemental workforce system establishes an electronic link and automated functions between hiring entities and workforce supplier entities. It further allows authorized members of the organization to submit changes to the documents and view the information in the data repository via a secure network connection. The automated features of the supplemental workforce system enable hands-free routing of a request from requisition to purchase order.

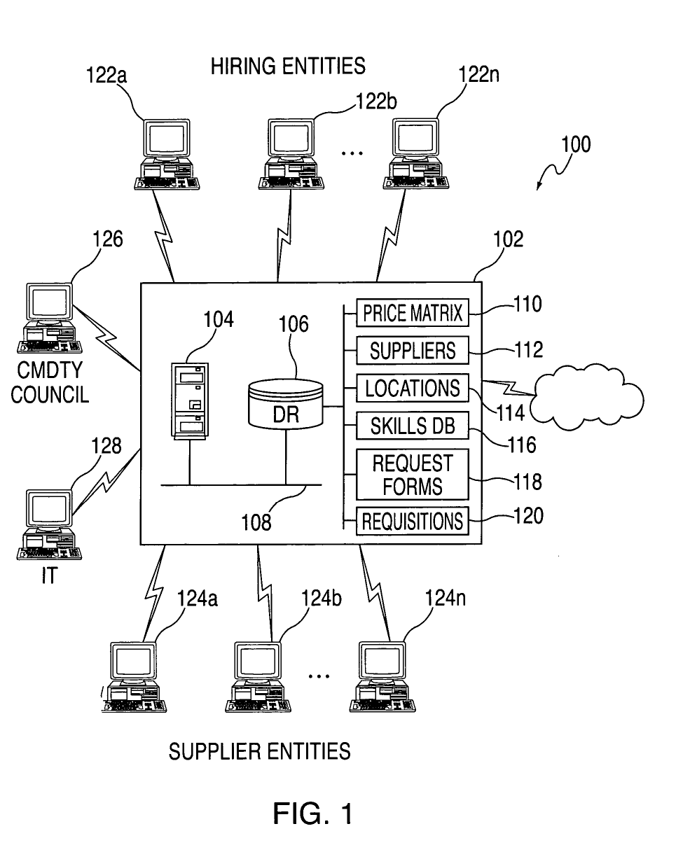

In an exemplary embodiment, the supplemental workforce system is implemented through a networked system such as that shown in FIG. 1. Although not necessary to realize the advantages of the present invention, system 100 may be part of a wide area network in which different geographical locations are interconnected, either by high-speed data lines or by radio links, interconnecting hundreds of workstations at widely disparate locations. In the simplified diagram of FIG. 1, system 100 includes host system 102 comprising a server 104 connected through a network 108 to data repository 106. Server 104 is running suitable web server software designed to accommodate various forms of communications and which allows information in data storage device 106 to be published on a web site. For purposes of illustration, server 104 is running Lotus Domino™ as its server software.

Host system 102 also executes various applications including a requisitioning tool, a procurement engine, a workflow application, and the supplemental workforce system. The supplemental workforce system enables the business enterprise to create and manage requisitions used for purchasing contract employees via the requisitioning tool. The procurement engine is a tool used to drive the finances of the business enterprise. The procurement engine executing on server 104 is used to create purchase orders and other financial transactions. The purchase orders are sent to supplier entities.

Host system 102 is also running a groupware application such as Lotus Notes™ which allows remote users to access information through its replication capabilities, provides e-mail services, and supports a secure extranet architecture.

A business enterprise utilizes the supplemental workforce system via host system 102 to implement a contract hiring process. The terms, “organization” and “business enterprise” refer to the system implementing the supplemental workforce system.

Network 108 may comprise a LAN, a WAN, or other network configuration known in the art. Further, network 108 may include wireless connections, radio-based communications, telephony-based communications, and other network-based communications. For purposes of illustration, however, network 108 is a LAN.

Data storage device 106 resides within intranet 108 and may comprise any form of mass storage device configured to read and write database type data maintained in a file store (e.g., a magnetic disk data storage device). Data storage device 106 is logically addressable as a consolidated data source across a distributed environment such as network system 100. The implementation of local and wide-area database management systems to achieve the functionality of data storage device 106 will be readily understood by those skilled in the art. Information stored in data storage device 106 is retrieved and manipulated via server 104.

Data storage device 106 provides a repository for databases including a price matrix database 110, a supplier database 112, a location database 114, a skills database 116, request form templates 118, a requisition database 120, and any other information desired by the business enterprise of host system 102 for use by the supplemental workforce system. These features are further described herein.

Hiring entities 122a-122n access host system 102 via internal web browsers located on entities 122a-122n. While the supplemental workforce system is described as being executed on host system 102, it will be understood by those skilled in the art that the supplemental workforce system may be executed entirely, or in part, on hiring entities 122a-122n as desired by the business enterprise. Hiring entities 122a-122n comprise computer systems such as a desktop computer, mobile computing device, or other suitable device. Hiring entities 122a-122n represent distinct divisions of the business enterprise and may be distinguished by geographic location, organizational structure, commodity groups, or other desirable method. Individuals operating hiring entities 122a-122n typically include representatives of the business enterprise charged with hiring supplemental workers on a contract basis. For example, a project manager for a local facility may be assigned the task of initiating one or more contract workers for a specific project. Another example may be a human resources manager for a regional office of the business enterprise who is asked to acquire supplemental workers over a specified time period.

Workforce supplier entities 124a-124n represent core suppliers of individuals available for contract work. Entities 124a-124n each a comprise computer system such as a desktop computer, mobile computing device, or other suitable device. Entities 124a-124n access host system 102 via internal web browsers located on entities 124a-124n, respectively.

Commodity council entity 126 and Internet technology (IT) entity 128, likewise comprise computer systems such as a desktop computer, mobile computing device, or other suitable device and access host system 102 via internal web browsers. Commodity council entity 126 is responsible for the administration of the supplemental workforce system functions for a given commodity (e.g., in a computer manufacturing industry, one commodity council handles computer memory devices while another commodity council manages computer cabling). Individuals of commodity council entity 126 negotiate and maintain agreements with core workforce suppliers. Authorized commodity council personnel may add or change core suppliers and can create and modify rate tables for price matrix database 110. Commodity council personnel select core suppliers (also referred to as preferred suppliers) utilizing a pricing algorithm. Commodity council entity 126 also oversees the implementation of the supplemental workforce system and ensures that each hiring entity is in compliance with regard to procuring only core suppliers at the pre-negotiated rates.

IT entity 128 receives information from commodity council entity 126 and configures the supplemental workforce system to implement the particular requirements in accordance with the supplier negotiations, job skills, and rate tables established by the commodity council.

Price matrix database 110 stores the most current price matrices for preferred workforce suppliers. Rate tables are preferably organized and stored by work location in order to provide hiring entities with local contractors in their area. The pricing algorithm used to select suppliers is determined by the commodity council or other suitable group of the business enterprise. The pricing algorithm takes into account various data elements such as experience, skills, past transactions with a supplier, salary requirements, supplier location, and other factors desired by the business enterprise. The supplemental workforce system automatically selects a supplier candidate based upon information provided by the hiring entity and information stored in one or more of databases 110-116. The supplemental workforce system is integrated with other utilities of the business enterprise such as the requisitioning tool and procurement engine for providing seamless and near hands-free operation.

The supplemental workforce system enables a business enterprise to save time by reducing the hiring activities typically associated with procurement supplemental workers. There is no need for competitive candidate selection by the hiring entities because each candidate is automatically selected by the supplemental workforce system utilizing information stored in price matrix database 110.

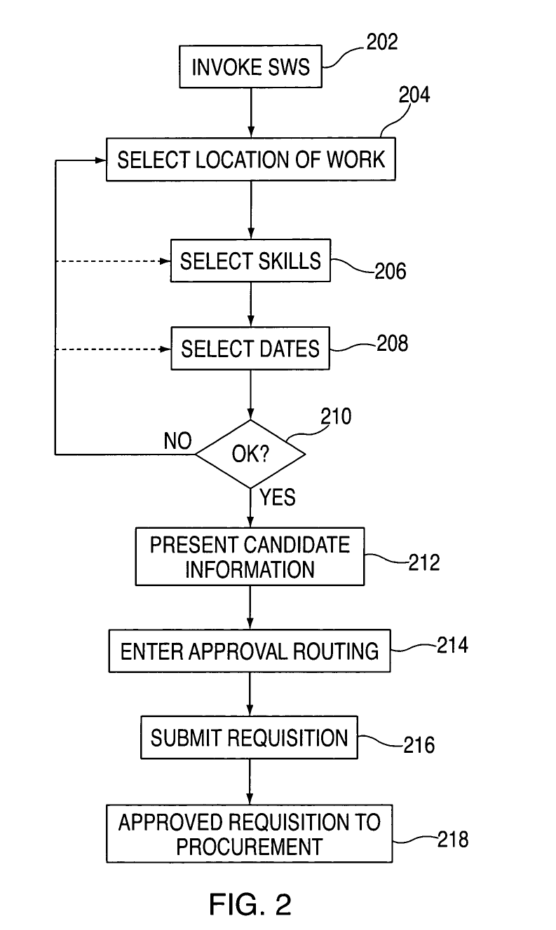

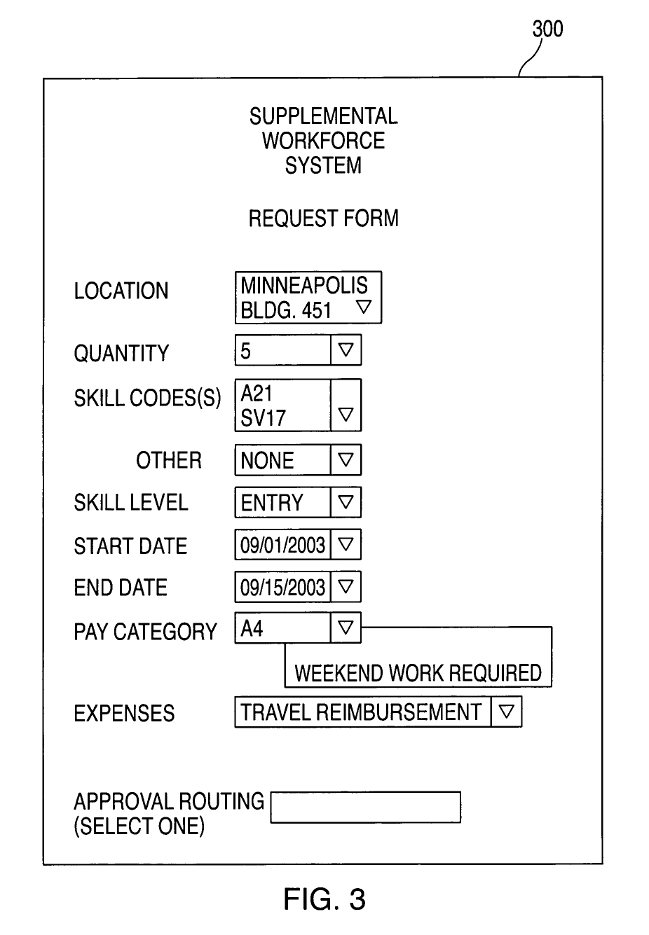

A requisition process flow is described in FIG. 2. This process assumes that a requester has accessed the requisitioning tool from server 104. The requisitioning tool may be a commercial product such as IBM's Req/CAT™, or may be another suitable application. The supplemental workforce system icon or option appears on the requester's computer screen along with options for selecting other utilities provided by the requisitioning tool. The requester selects the supplemental workforce system option at step 202 and a request form template screen appears displaying a template from database 120. A sample template with data is shown generally in FIG. 3. The location of the work to be performed is selected at step 204. A database of work locations 114 is stored in database 114 and is readily accessible to the requester for this option. The requester is queried to enter or select one or more skills and the number of workers required for the job at step 206. Skills are predefined by the business enterprise and preferably coded for easy and consistent access. Skill levels or level of experience can be factored into the skill code structure to differentiate between workers of varying levels of experience and for purposes of negotiating compensation. This feature is also preferably provided as a database of skills 116 and skill codes that are selectable by a requester of the hiring entity for administrative consistency. Any unusual or uncommon skills may be entered by an editable text field provided by the supplemental workforce system. At step 208, the requester selects or enters a date or date range for the job. The supplemental workforce system provides a feature whereby the hiring entity can indicate the method of compensation whereby the supplemental workforce system in turn calculates the pay automatically based upon straight time, overtime, weekend or holiday, and may override standard payment options. The hiring entity may also indicate whether travel or other miscellaneous expenses shall be reimbursed.

Alternatively, the activities recited in steps 204-208 may be performed via a separate application such as the tool recited in co-pending patent application, Document No. 20020095300, entitled “Skills Matching Application”, filed on Jul. 12, 2001 by the assignees of the present invention, and is incorporated herein by reference in its entirety. The Skills Matching Application of the referenced invention allows a user to initiate a request for a contractor by entering specific information about the job or project at hand. The information is sent by email to one or more suppliers who review the information and submit information (e.g., a resume) relating to a potential candidate. The user/requester can accept or decline the candidate as desired.

Once the request information is entered, the requester may be queried to review the entries provided in the requisition request before submitting the information. If the requester would like to make any changes at step 210, the requisition request may be edited. Changes may be made before or after the requisition and purchase order are executed but may require some approval routing for tracking purposes. The process reverts to one of steps 204-208 depending upon the nature of the changes to be made. At step 210, if the requester approves of the information entered, the request is submitted to the supplemental workforce system. The supplemental workforce system presents candidate and pricing information at step 212 from price matrix database 110 based upon the information entered in the request form. Candidate information includes supplier data such as supplier name, address, telephone, point of contact, and similar information. Pricing information includes the pre-determined fees for contracting the services specified in the request. This information is obtained from price matrix database 110.

The requester enters the name or email address of one or more approvers for the request at step 214. The supplemental workforce system ensures that the request is distributed through a routing process whereby authorized individuals review the request via one or more of hiring entities 122a-122n, and/or commodity council entity 126, and determine whether to approve of the request. Once approved, the supplemental workforce system creates a requisition utilizing the information in the request form, and submits it to the requisitioning tool at step 216 where it is stored in requisition database 120. It is then forwarded to the procurement engine at step 218 where a purchase order is generated. The purchase order is ready to be sent to the appropriate supplier at one of supplier entities 124a-124n.

FIG. 3 illustrates an exemplary request form 300 that is used by the supplemental workforce system. Fields of information provided on request form 300 may be edited and customized by the business enterprise and/or its members in order to better represent its organizational structure.

The supplemental workforce system is integrated with a requisitioning tool and procurement engine for implementing a semi-automated contract hiring system. The supplemental workforce engine enables a business enterprise to save time by reducing the hiring activities typically associated with procuring supplemental workers. The preferred supplier is automatically selected by the supplemental workforce system based upon information provided by the hiring entity in the request form and submitted to a requisition tool and procurement engine for quick implementation.

As described above, the present invention can be embodied in the form of computer-implemented processes and apparatuses for practicing those processes. The present invention can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While preferred embodiments have been shown and described, various modifications and substitutions may be made thereto without departing from the spirit and scope of the invention. Accordingly, it is to be understood that the present invention has been described by way of illustration and not limitation.

1. A method of procuring a supplemental worker for a job, comprising:
receiving a request form from a hiring entity for a supplemental worker, said request form including:
a work location;
at least one skill type;
a skill level associated with said at least one skill type; and
a quantity of supplemental workers required for performing said job;
generating a list of at least one supplier candidate by accessing a data repository, said list of at least one supplier candidate satisfying criteria provided in said request form; and
providing said list of at least one supplier candidate to said hiring entity;
wherein said data repository stores predefined skill types, predefined skill levels, supplier locations, and pre-negotiated pay rates.

2. The method of claim 1, further comprising:
upon acceptance of said request form, automatically transmitting said request form to a requisitioning tool, said requisitioning tool operable for generating a requisition; and
upon approval of said requisition, automatically transmitting said requisition to a procurement engine, said procurement engine operable for generating a purchase order.

3. The method of claim 1 wherein said skill types are coded and selectable by said hiring entity.

4. The method of claim 1, wherein said request form includes an editable text field operable for entering a skill type.

5. The method of claim 1, wherein said request form includes a pay category option operable for calculating a salary.

6. The method of claim 1, wherein information relating to said list of at least one supplier candidate is stored in said data repository, said information including:
a supplier name;
a supplier address;
a supplier telephone number;
a point of contact; and
pre-negotiated pricing information based upon skill types and skill levels.

7. A storage medium encoded with machine-readable computer program code for procuring a supplemental worker for a job, said storage medium including instructions for causing a computer to implement:
receiving a request form from a hiring entity for a supplemental worker, said request form including:
a work location;
at least one skill type;
a skill level associated with said at least one skill type; and
a quantity of supplemental workers required for performing said job;
generating a list of at least one supplier candidate by accessing a data repository, said list of at least one supplier candidate satisfying criteria provided in said request form; and
providing said list of at least one supplier candidate to said hiring entity;
wherein said data repository stores predefined skill types, predefined skill levels, supplier locations, and pre-negotiated pay rates.

8. The storage medium of claim 7, further comprising instructions for causing said computer to implement:
upon acceptance of said request form, automatically transmitting said request form to a requisitioning tool, said requisitioning tool operable for generating a requisition; and
upon approval of said requisition, automatically transmitting said requisition to a procurement engine, said procurement engine operable for generating a purchase order.

9. The storage medium of claim 7 wherein said skill types are coded and selectable by said hiring entity.

10. The storage medium of claim 7, wherein said request form includes an editable text field operable for entering a skill type.

11. The storage medium of claim 7, wherein said request form includes a pay category option operable for calculating a salary.

12. The storage medium of claim 7, wherein information relating to said list of at least one supplier candidate is stored in said data repository, said information including:
a supplier name;
a supplier address;
a supplier telephone number;
a point of contact; and
pre-negotiated pricing information based upon skill types and skill levels.

13. An integrated system for procuring a supplemental worker for a job comprising:
a host system in communication with at least one hiring entity, at least one supplier entity, and a commodity council entity, said host system comprising:
a server executing a requisitioning tool, a procurement engine, and a workflow application;
a data repository in communication with said server via a network, said data repository storing predefined skill types, predefined skill levels, supplier locations, and pre-negotiated pay rates;
a supplemental workforce system executing on said server; and
a request form generated by said supplemental workforce system;
wherein said supplemental workforce system performs:
receiving a completed request form from a hiring entity for a supplemental worker, said completed request form including a work location, at least one skill type, a skill level associated with said at least one skill type, and a quantity of supplemental workers required for performing said job;
generating a list of at least one supplier candidate by accessing said data repository, said list of at least one supplier candidate satisfying criteria provided in said completed request form; and
providing said list of at least one supplier candidate to said hiring entity.

14. The system of claim 13, wherein said supplemental workforce system automatically transmits said completed request form with an approved supplier candidate to said requisitioning tool operable for generating a requisition.

15. The system of claim 14, wherein said supplemental workforce system automatically transmits said requisition to said procurement engine operable for generating a purchase order.
